(19) United States
(12) Patent Application Publication
(10) Pub. No.: US 2005/0062187 A1
(43) Pub. Date: Mar. 24, 2005

(54) Method for producing a rubber ball having a simulated sewing pattern

(75) Inventor: Sahuts Srikijkarn, Amphur Meuang Samutprakarn (TH)

Correspondence Address: VOLPE AND KOENIG, P.C., UNITED PLAZA, SUITE 1600, 30 SOUTH 17TH STREET, PHILADELPHIA, PA, 19103, US

(73) Assignee: Siam Ball Sport Factory Co., Ltd., Amphur Meuang Samutprakarn (TH)

(21) Appl. No.: 10/926,891

(22) Filed: Aug. 26, 2004

(30) Foreign Application Priority Data
Sep. 19, 2003 (TH) 0303000937

(51) Int. Cl. B29C 43/00

(52) U.S. Cl. 264/103; 264/325; 264/349; 264/175

(57) ABSTRACT

A method of producing a rubber ball with a simulated sewing pattern.

### FIELD OF THE INVENTION

Engineering and chemical in the part of the method for produce rubber ball looks like sewing pattern.

### SUMMARY OF THE INVENTION

The method for produce rubber ball looks like sewing pattern comprising with steps of natural rubber mixed with chemical compounds to produce the ball which has two layers, inner bail or called bladder rubber and outer layer. The outer layer made from pieces of patterned rubber or patch attached onto bladder rubber and combined together by molding machine. Said pieces of rubber can be prepared in desire pattern.

The method according to this invention can produce rubber ball looks like sewing pattern and take less time than prior method. The product has durable quality and proof water.

### BRIEF DESCRIPTION OF THE PRIOR ART

The ball production by conventional method is human hand-made. Of course they need the man skill in the art for sewing leather to make the ball. The ball come from this method are uncertain in quality and water can pass through the tiny needle holes. And the ball will downgrade easily

### DETAILED DESCRIPTION OF THE INVENTION

The method for produce rubber ball looks like sewing pattern comprising;
Step of making bladder rubber
Step of making pieces of rubber or patches for outer layer
Step of combine patches onto bladder rubber in order to making rubber ball looks like sewing pattern

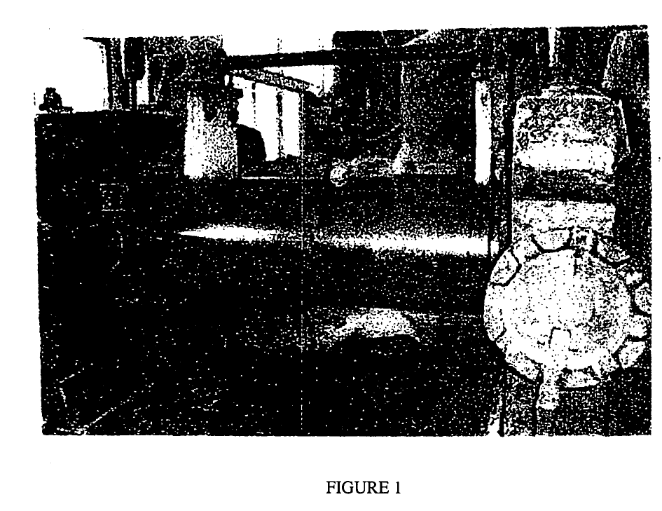

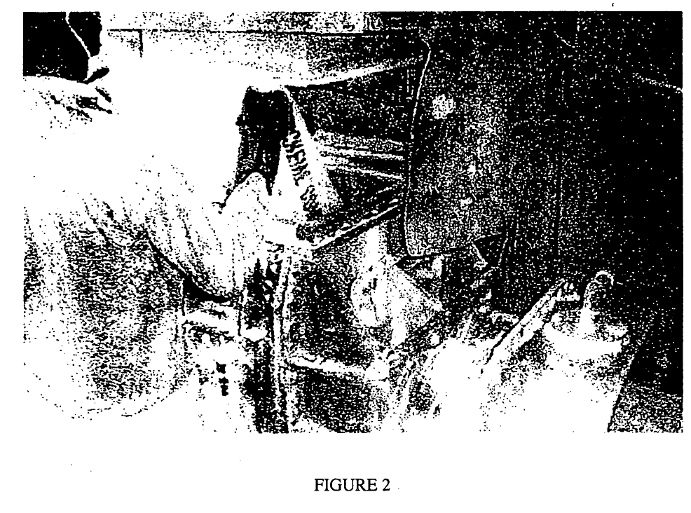

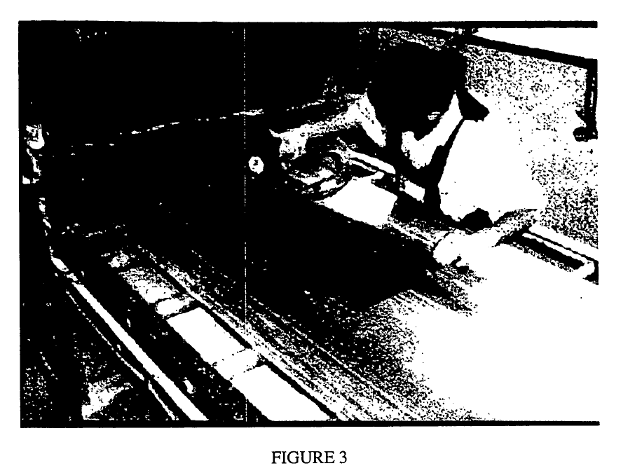

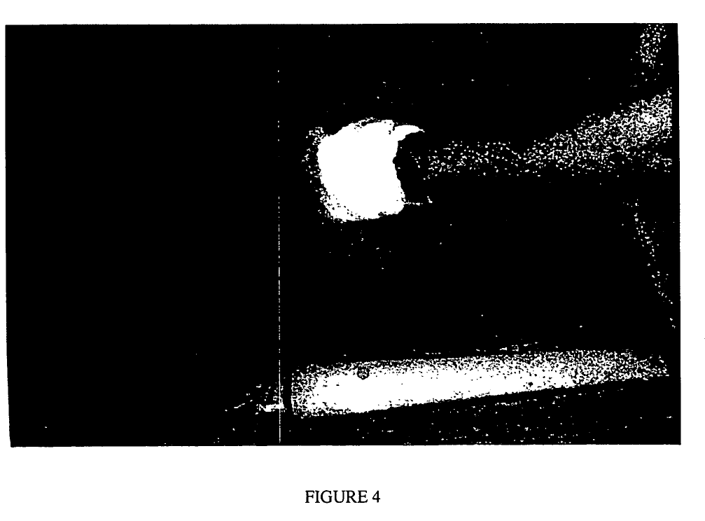

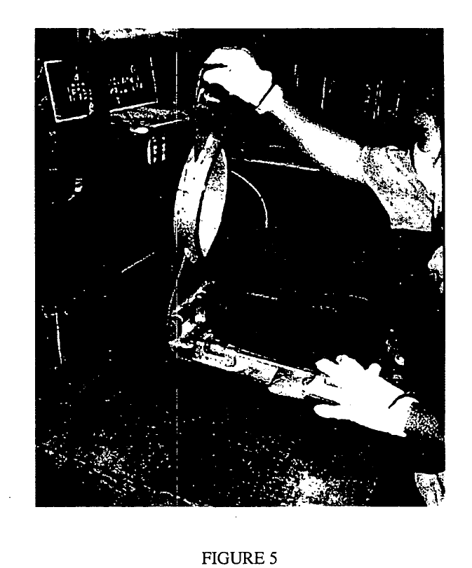

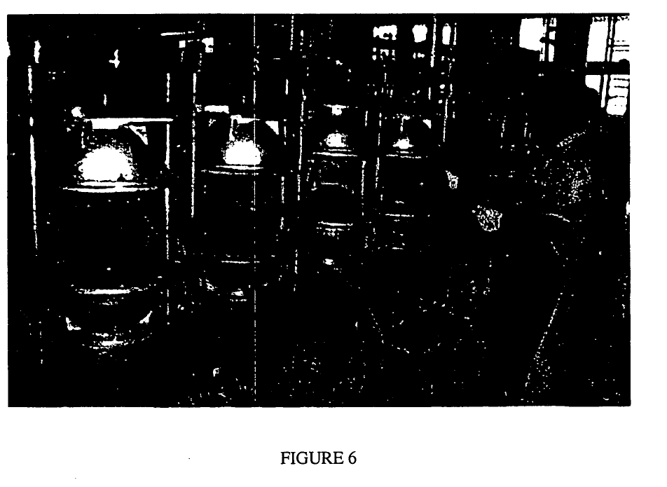

Step of Making Bladder Rubber (Also Referred to as a Rubber Bladder)
1. Bring the rubber mixed with MASTERBATCH and SBI 1 masticate for 2 minute (as shown in FIG. 1).
2. Bring the rubber from (1) mixing with chemical compound and masticate again for a minute. After that immerse this rubber in starch slurry and dry (as shown in FIG. 2).
3 Bring the rubber from (2) masticate for 1 minute to make it softer then calender by calender machine at temperature 60-90° C. adjust the thickness for 0.95-1.05 mm to make sheet of rubber (as shown in FIG. 3).
4. Bring the rubber sheet from (3) install the air filling tube at position about 9-12 inch from rim (as shown in FIG. 4).
5. Bring rubber sheet from (4) fold and lay on knife block (round shape) to press and cut said folded rubber sheet at temperature 60-100° C. Now the folded rubber sheet is cut in round shape and sealed at the rim form bladder rubber. The weight Is about 130-150 grams (as shown in FIG. 5).
6. Curing the bladder rubber from (5) at temperature 155-165° C. by electric curing machine but for streamer curing machine the pressure should not less than 5.5 Kg/cm and curing time about 3 minutes (as shown in FIG. 6).
7. Bring the bladder rubber from (6) install the air filling tube valve.

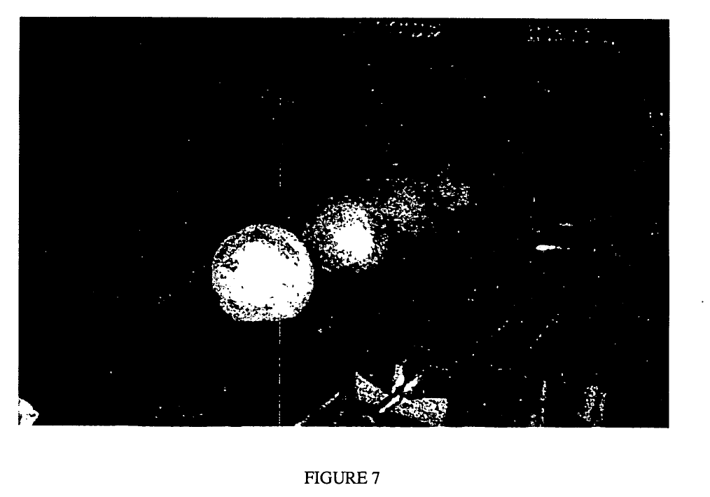

Compare the bladder rubber size with template if the size are equal winding the bladder rubber by winding machine. Winding the bladder rubber will support the shape of ball in sphere all the time of use. The appropriate cycle is about 1,200 cycles (as shown in FIG. 7).

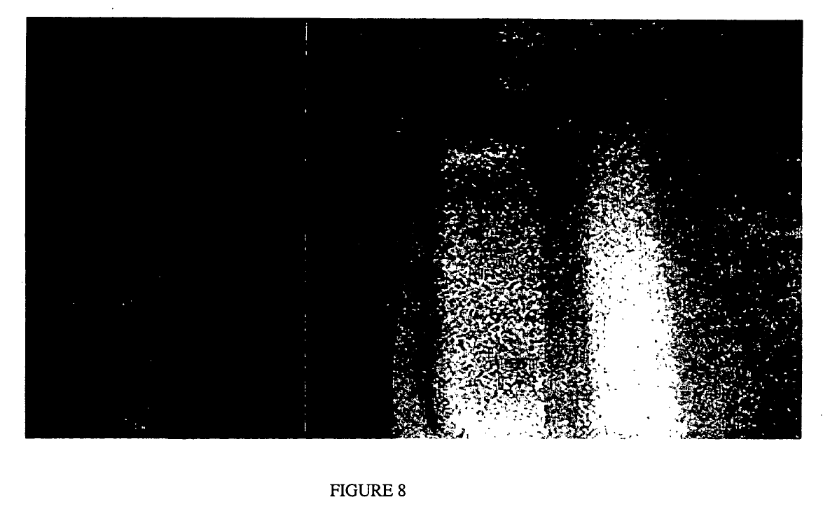

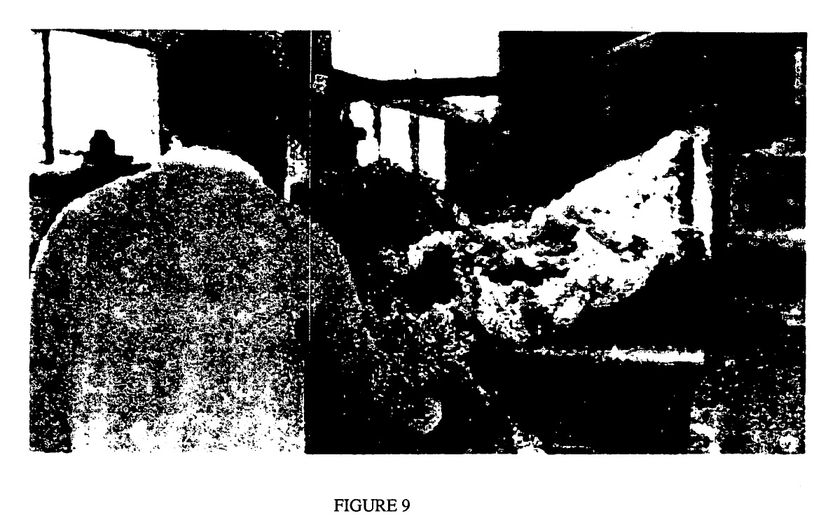

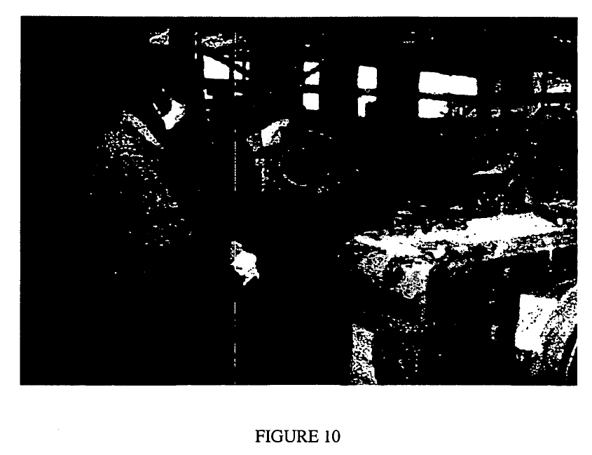

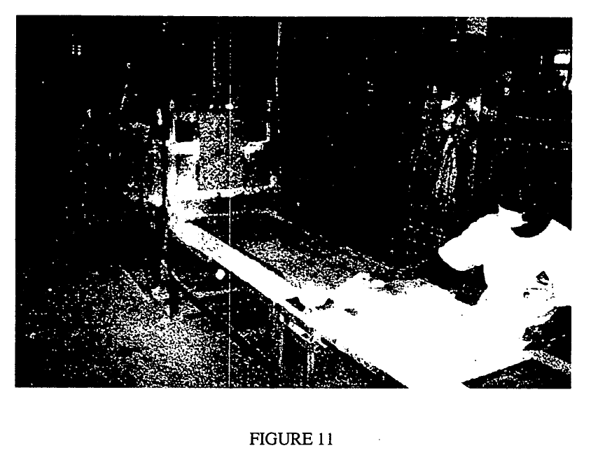

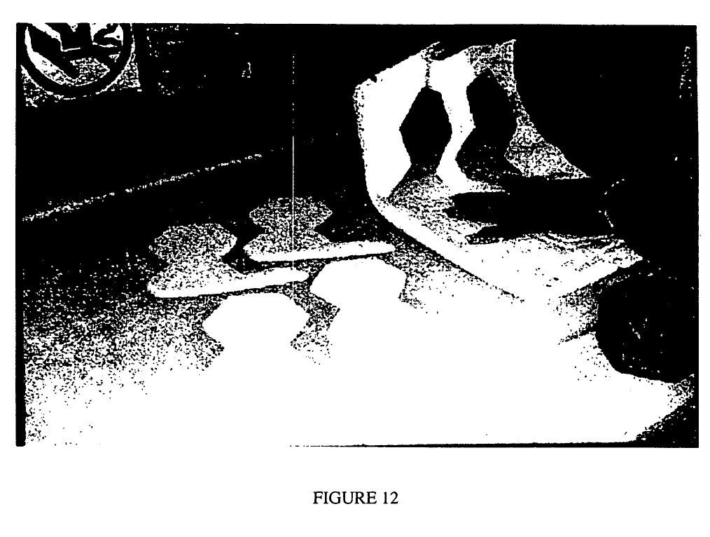

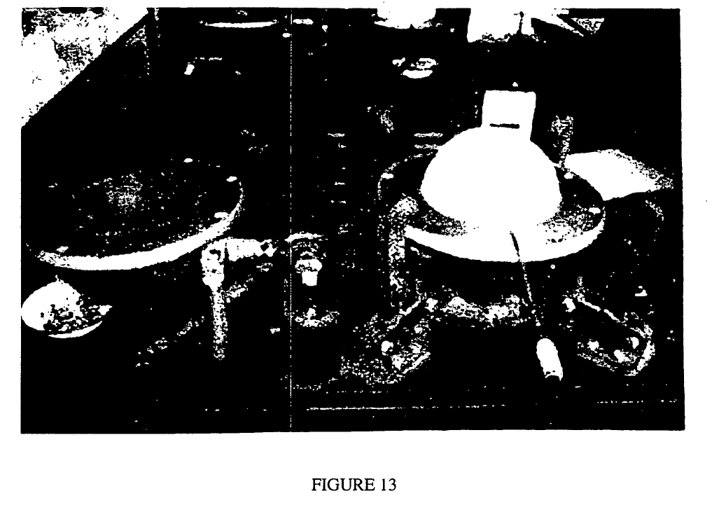

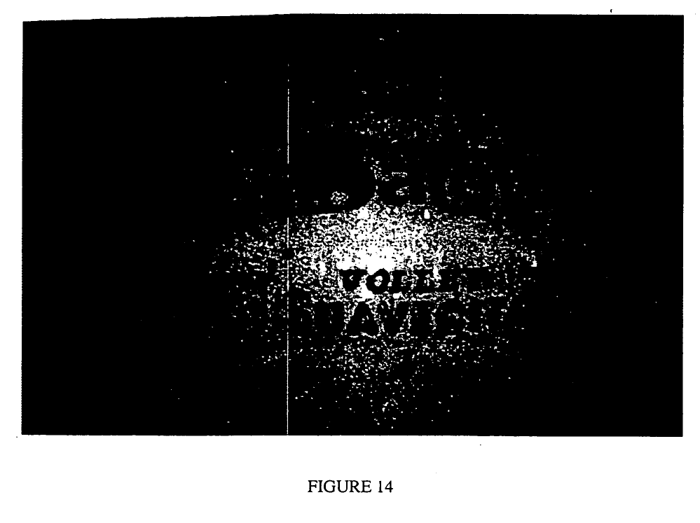

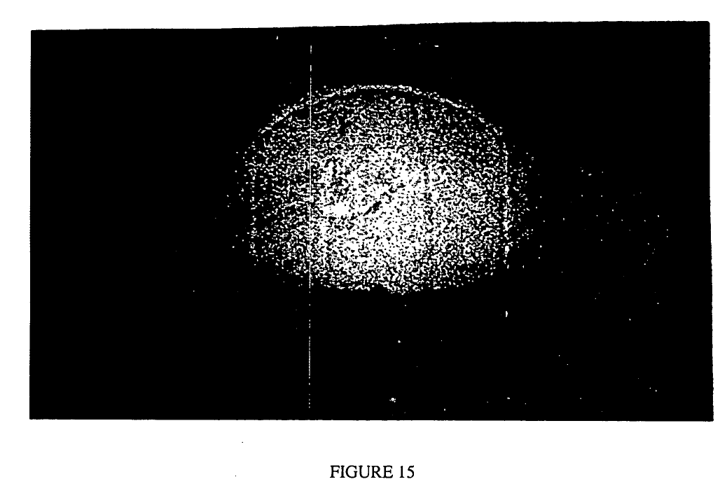

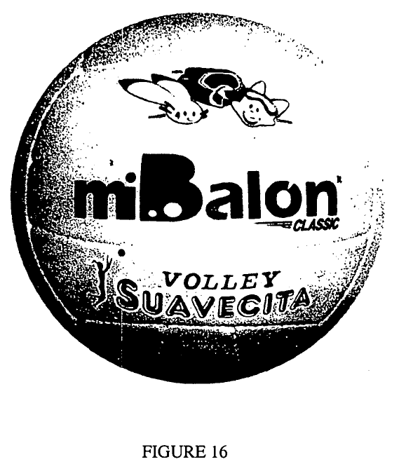

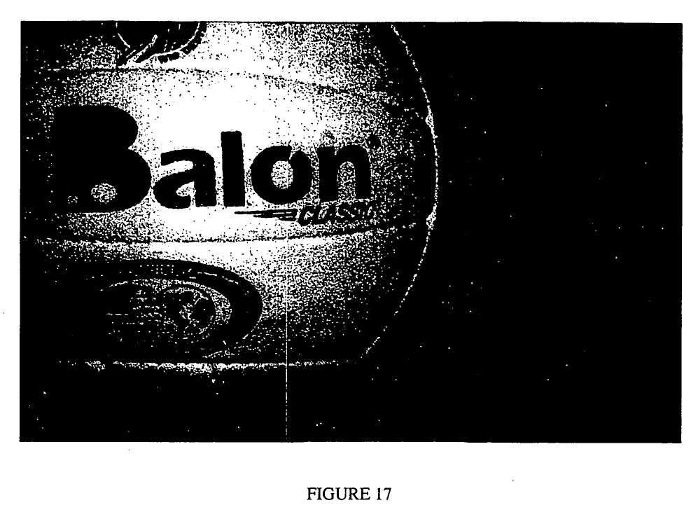

Step of Making Pieces of Rubber or Patches for Outer Layer
1. Mix natural rubber and synthetic rubber masticate for 2 minutes then add desired color and further masticate about 5 minutes and mix prepared chemical compound (as shown in FIGS. 8 and 9).
2. Bring the rubber from (1) mix with Sulphur and masticate about 5 minutes then immerse in starch slurry for a moment and then dry in the air. (as shown in FIG. 10)
3. Bring the rubber from (2) masticate or knead for 1 minute until it become softer. Calender rubber by calender machine at temperature 60-90° C. and adjust the thickness of rubber sheet 1.2-1.5 mm (as shown in FIG. 11).
4. Cut rubber sheet from (3) into pieces in desired pattern. Now we will have pieces of rubber or rubber patches for attach onto bladder rubber (as shown in FIG. 12).
   Step of Combine Patches onto Bladder Rubber in Order to Making Rubber Ball Looks Like Sewing Pattern
1. Bring pieces of rubber or patches from the above attach to inside of mold and bring the winded bladder put on the mold and combine together (as shown in FIG. 13).
2. For any brand logo or decoration sticker if need can be attached (as shown in FIG. 14).
3. Bring the ball from (2) curing in the mold specific character; said specific character is the mold has ridge corresponding to the rim of patches or pieces of rubber in order to make groove at the rim of patches or pieces of rubber in to inside the ball. Cause it looks like sewing pattern. Curing the ball for 18 minutes and install small air filling tube and cleaning the ball surface to finish product (as shown in FIGS. 15-17).
   The method for produce rubber ball looks like sewing pattern comprising with steps of natural rubber mixed with chemical compounds to produce the ball which has two layers, inner ball or called bladder rubber and outer layer. The outer layer made from pieces of patterned rubber or patch attached onto bladder rubber and combined together by molding machine. Said pieces of rubber can be prepared in desire pattern.

The method according to this invention can produce rubber ball looks like sewing pattern and take less time than prior method. The product has durable quality and proof water.

| | |
|---|---|
| Mixture Compounds | Weight |

ASTP ATCH (Mixed at Trap Products Co., Ltd.)

| | |
|---|---|
| RSS-1 | 50 Kilograms |
| N-33(? | 10 Kilograms |
| N-550 | 17.5 Kilograms |
| H-1 6 2 OIL | 5 Kilograms |
| STFARIC ACID | 1 Kilogram |
| ANTIOXIDANT SUNTIGHT-S | 1 Kilogram |
| LT OW | 500 Grams |
| VOLKANOX MB-2/MG | 125 Grams |
| TOTAL | 85.125 Kilograms |
| Rubber weight ± 200 grams | |

S B-11 (Mixed at Trap Products Co., Ltd.)

| | |
|---|---|
| B 3X-2,2255 | 50 Kilograms |
| N-550 | 10 Kilograms |
| N-660 | 20 Kilograms |
| 916011, | 3.3 Kilograms |
| Ca Coz SUPER GRADE | 5 Kilograms |
| STEARIC ACID | 930 Grams |
| A-100 | 860 Grams |
| TOTAL | 90.09 Kilograms |
| Rubber weight ± 200 grams | |

Inner rubber 30% (Main Machine)

| Mixture Compounds | Weight |
|---|---|
| MASTERBATCH | 24 Kilograms |
| SB 11 | 9 Kilograms |
| ZINC OXIDE 99.5% | 500 Grams |
| TOTAL | 33.5 Kilograms |
| PERKACIT TMTM | 50 Grams |
| ACCEL DM-R (DM) | 25 Grams |
| SANTOCURE MBS (MOR) | 80 Grams |
| C URAGE.NT-S | 360 Grams |
| TOTAL | 34.01 Kilograms |
| Rubber weight ± 200 grams | |

List of Machines Preferably Used in Manufacture of Rubber Material
1) Machine for mixing of rubber in close type (Internal Mixer)
2) Machine for mixing of rubber in open type (Open Mill)—Two Roll Mill
3) Machine for calendering rubber (Calender Machine)—Calender
4) Machine for folding of inner rubber
5) Machine for curing of inner rubber (Curing Mould)

1. A method for producing a rubber ball having an outer surface with a simulated sewing pattern, comprising the steps of:
making a rubber bladder, comprising:
at least one of grinding, kneading, and mixing a rubber with MASTERBATCH and SB 11 for approximately two (2) minutes;
at least one of grinding, kneading, and mixing the rubber with a chemical compound for approximately one (1) minute;
immersing the rubber in a starch slurry;
allowing the rubber to dry;
at least one of grinding, kneading, and mixing the rubber for approximately one (1) minute to make the rubber softer;
adjusting a thickness of the rubber while the rubber is at a temperature of between approximately sixty (60) degrees Celsius and approximately ninety (90) degrees Celsius so that the thickness is between approximately zero point ninety-five (0.95 mm) millimeters and approximately one point zero five (1.05 mm) millimeters so that that rubber forms a sheet of rubber;
pressing and folding the rubber sheet on a round shape while at a temperature of between approximately sixty (60) degrees Celsius and one hundred (100) degrees Celsius;
cutting and sealing the rubber sheet to form the rubber bladder with a weight of between approximately one hundred thirty (130) grams and approximately one hundred fifty (150) grams;
curing the rubber bladder for approximately three (3) minutes at a temperature of between approximately one hundred fifty-five (155) degrees Celsius and approximately one hundred sixty-five (165) degrees Celsius ° C. at a pressure of not less than approximately five point five (5.5 Kg/cm2) kilograms per square centimeter;
installing an air filling tube and valve in the rubber bladder;
comparing a size of the rubber bladder with a template and if the rubber bladder is properly sized, winding the rubber bladder using approximately twelve hundred (1,200) cycles in a winding machine;
making a plurality of patches for the outer surface of the rubber ball, comprising:
forming a rubber by at least one of grinding, kneading, and mixing a natural rubber and a synthetic rubber masticate for approximately two (2) minutes and then adding a coloring material and further at least one of grinding, kneading, and mixing for approximately five (5) minutes;
at least one of grinding, kneading, and mixing the rubber with Sulphur for approximately five (5) minutes;
immersing the rubber in a starch slurry;
allowing the rubber to air dry;
kneading the rubber for approximately one (1) minute;
calendaring the rubber at a temperature of between approximately sixty (60) degrees Celsius and approximately ninety (90) degrees Celsius to form the rubber into a rubber sheet having a thickness of the rubber to be between approximately one point two (1.2) millimeters and approximately one point five (1.5) millimeters;
cutting the rubber sheet into the patches each having a desired pattern;
combining the patches with the rubber bladder to form a rubber ball having the simulated sewing pattern, comprising:
placing the patches to an inside of a mold and position the rubber bladder in the mold to combine together;
forming the rubber ball by curing the patches and the rubber bladder in the mold so that a plurality of ridges are formed by a perimeter of each of the patches to create the simulated sewing pattern.

2. A method for producing a rubber ball having an outer surface with a simulated sewing pattern, comprising the steps of:
making a rubber bladder;
making a plurality of rubber patches to form the outer surface of the rubber ball, comprising:
forming a rubber by mixing a natural rubber and a synthetic rubber;
mixing the rubber with Sulphur;
immersing the rubber in a starch slurry;
allowing the rubber to dry;
forming the rubber into a rubber sheet;
cutting the rubber sheet into the plurality of rubber patches each having a perimeter;
curing the rubber patches and the rubber bladder so that a plurality of ridges are formed by the perimeter of each of the patches to create the simulated sewing pattern.

3. A method for producing a rubber soccer ball having an outer surface with a simulated sewing pattern, comprising the steps of:
making a rubber bladder;
making a plurality of rubber patches to form the outer surface of the rubber ball;
curing the rubber patches and the rubber bladder so that a plurality of ridges are formed by the perimeter of each of the patches to create the simulated sewing pattern.
